(19) United States
(12) Patent Application Publication
(10) Pub. No.: US 2021/0188397 A1
(43) Pub. Date: Jun. 24, 2021

(54) SELECTION SYSTEM OF THE TRANSMISSION GEARS IN BICYCLES OR THE LIKE

(71) Applicant: C.OR.AL., S.R.L., Modena (MO) (IT)

(72) Inventor: Alfonso ORFELLO, Modena (MO) (IT)

(73) Assignee: C.OR.AL., S.R.L., Modena (MO) (IT)

(21) Appl. No.: 16/756,858

(22) PCT Filed: Oct. 17, 2018
(86) PCT No.: PCT/IB2018/058062

§ 371 Date: Apr. 17, 2020

(30) Foreign Application Priority Data
Oct. 17, 2017 (IT) 102017000116847

(51) Int. Cl. B62M 9/14; B62K 25/02

(52) U.S. Cl. CPC B62M 9/14; B62K 2025/025; B62K 25/02

(57) ABSTRACT

The selection system (1) of the transmission gears in bicycles or the like comprises a cogset (2) associated axially sliding with a hub (3) of a wheel (R) of a bicycle (B) and provided with a plurality of cogs (4) of different sizes and arranged alongside one another, starting from the smallest-sized cog (4a) to the largest-sized cog (4b), and movement means (5) of the cogset (2) on the hub (3) between a first extreme position, in which the smallest-sized cog (4a) is positioned on a transmission chain (C) of the bicycle (B), and a second extreme position, in which the largest-sized cog (4b) is positioned on the chain (C), the cogset (2) being associated with the hub (3) with the smallest-sized cog (4a) facing the wheel (R) and with the largest-sized cog (4b) facing outwards, wherein the selection system (1) comprises quick assembly/removal means (19) of the wheel (R) independently of the cogset (2).

### TECHNICAL FIELD

The present invention relates to a selection system of the transmission gears in bicycles or the like.

### BACKGROUND ART

With reference to bicycles, from standard bicycles to racing bicycles and so-called mountain bikes, the use has long been known and widespread of gears adapted to allow the selection of different transmission gears, so as to make pedalling easier and adapt it to the different characteristics of the route. In particular, the most common type of bicycle gears is the so-called derailleur gear system.

The derailleur gear system comprises a series of gear wheels of different and predefined sizes, positioned side by side, and a mechanism controlled by the rider, known as the derailleur gear, adapted to move the chain from one gear wheel to another and to keep the chain taut.

In general, in standard bicycles there is only one set of gear wheels, so-called cogs, mounted integral on the hub of the rear wheel and only one rear derailleur, while racing bicycles or mountain bikes can have several crown gears positioned side by side at the pedals and a second front derailleur.

In particular, mountain bikes generally have a maximum of ten cogs on the rear wheel and a maximum of three crown gears at the pedals, for a total of thirty possible transmission gears, while racing bikes generally have at most eleven cogs on the rear wheel and at most two crown gears at the pedals, for a maximum of twenty possible transmission gears.

The gears are controlled by one or more special levers, by means of which it is possible to start the movement of the chain from one cog to another and/or from one crown to another.

One of the most widely used solutions, for example, uses a control equipped with a pair of levers installed on the handlebar, wherein a first lever of larger size, once operated, stretches the gear cable, moving the derailleur gear and shifting the chain onto cogs of larger size.

The operation of a second lever, on the other hand, causes the cable to be released, moving the derailleur gear and shifting the chain onto smaller cogs. However, known types of gears have a number of drawbacks.

In particular, a first drawback is the fact that the continuous movements of the chain on the cogs and on the crown gears, together with the fact that the chain has in many cases to operate in an offset, and therefore inclined position, compared to the teeth of the cogs and of the crown gears, results in considerable wear to the chain itself.

As a result, the chain becomes less and less functional over time and can even break, with obvious risk for the cyclist, and therefore requires continuous maintenance and inspection and periodic replacement.

Furthermore, another drawback is the fact that, because it operates in an inclined position with respect to the teeth of the cogs and the crown gears, the risk increases considerably of the chain falling off, with all consequent problems and risks.

Another drawback is the fact that when operating in an inclined position with respect to the teeth of the cogs and crown gears, the forces transmitted to the chain by the action on the pedals comprise a lateral component and, therefore, not all the energy applied to the pedals is transmitted to the cogs.

Another drawback is the fact that the number of maximum possible transmission gears is limited, on the one hand, by the maximum dimensions of the cogset at the hub of the rear wheel, and on the other hand by the maximum stroke and inclination of the chain with respect to the teeth, which cannot be excessive.

Last but not least drawback is the fact that, in order to overcome all the above-mentioned problems, the chain itself and the teeth and structure of the cogs and crown gears have to be machined, shaped and sized in such a way as to facilitate the engagement of the chain on the teeth with any possible inclination, as well as to reduce the overall weight of the cogset.

It is therefore necessary to make chains and cogs suitably shaped and with an increasingly lesser thickness, with a considerable increase in the overall costs for manufacturing the gear system.

The fact should also be noticed that increasingly thinner cogs also imply chains of increasingly reduced thickness and, therefore, more fragile and more prone to breakage.

In order to partially overcome these drawbacks, the solution described in document WO 2014/054017 A1 is known. More specifically, this document describes a cogset for bicycle gear systems comprising: a plurality of first mobile cogs, associated sliding and integral in rotation with the hub of a wheel of a bicycle and adapted to be moved alternately along a sliding direction between a first retracted position and a first working position, wherein they are adapted to be engaged by the bicycle chain; a plurality of second mobile cogs of different diameter compared to the first mobile cogs, associated sliding and integral in rotation with the hub and adapted to be moved between a second retracted position and a second working position, defined in the proximity of the first working position, wherein they are adapted to be engaged by the chain; movement means operationally associated with the first and second mobile cogs and adapted to move the first and second mobile cogs in succession between the first and second retracted position and the first and second working position. This solution however is also susceptible of upgrading.

In particular, despite the inclination of the chain in the working positions being reduced to the utmost, the chain is not always kept perfectly in line with the cogs. Therefore, although considerably reduced, the problems described above with reference to known solutions are not completely fixed.

Moreover, such known solution is considerably complex. In particular, the movement of the individual cogs between the retracted positions and the working positions requires the implementation of a complex drive mechanism which is not easy to make.

Also known, furthermore, are the solutions described in documents DE 41 29 198 A1 and U.S. Pat. No. 2,117,116. More specifically, such solutions involve the use of a cogset sliding along the hub of the rear wheel of the bicycle. The cogset is moved in such a way that the individual cogs are positioned at the chain, while keeping the chain stationary and in line.

Nevertheless, even these solutions are not without drawbacks.

In particular, the specific positioning of the cogset and the specific movement mechanism considerably limit the stroke amplitude of the cogset itself, thus limiting the number of cogs that can be used and, therefore, the number of possible transmission gears.

Documents WO 00/68068 A1 and FR 2 522 102 A1 describe solutions wherein a cogset is associated sliding with the rear wheel hub of a bicycle with the smallest-sized cog facing the wheel and the largest-sized cog facing the outside. However, even these solutions have considerable drawbacks.

In particular, the specific cogset fixing and movement systems make it difficult or even impractical to remove the wheel in a short time, e.g., in the case of a puncture.

### DESCRIPTION OF THE INVENTION

The main aim of this invention is to devise a selection system of the transmission gears which allows the chain to be kept stationary and in line during use, while at the same time allowing the use of a large number of cogs. Another object of the present invention is to devise a selection system of the transmission gears in bicycles or the like which allows a simple and rapid replacement of the wheel.

The aforementioned objects are achieved by the present selection system of the transmission gears in bicycles or the like according to the characteristics described in claim 1.

The aforementioned objects are also achieved by the present quick removal/assembly means of a wheel in bicycles according to the characteristics described in claim 15.

### BRIEF DESCRIPTION OF THE DRAWINGS

Other characteristics and advantages of the present invention will become more evident from the description of two preferred, but not exclusive embodiments of a selection system of the transmission gears in bicycles or the like, illustrated by way of an indicative, but non-limiting example, in the attached drawings in which: FIG. 1 shows the system according to the invention installed on a bicycle and according to a first possible embodiment;

FIG. 2 and FIG. 3 are top and partly sectional views illustrating the movement of the cogset of FIG. 1 between a first extreme position and a second extreme position;

FIG. 4 is a top and sectional view of the selection system of FIG. 1 with the cogset in a first extreme position;

FIG. 5 is a top and sectional view of the selection system of FIG. 1 with the cogset in a second extreme position;

FIG. 6 schematically shows removal/assembly means of a wheel of the system of FIG. 1;

FIGS. 7 and 8 show removal/assembly means of a wheel according to a possible further embodiment.

### EMBODIMENTS OF THE INVENTION

With particular reference to these figures, reference numeral 1 globally indicates a selection system of the transmission gears installable on a bicycle B. The system 1 can be used on any conventional bicycle, to replace traditional gear selection systems.

In particular, the system 1 comprises a cogset 2 associated axially sliding with a hub 3 of a wheel R of a bicycle B.

In particular, the hub 3 comprises a central supporting axis 13 locked together with the forks F of the bicycle B and a supporting body 7 for the wheel R which is associated revolving with the central supporting axis 13.

The cogset 2 is locked together in rotation with the body 7 in the direction of travel and is associated axially sliding with the central supporting axis 13. Advantageously, the supporting body 7 of the wheel R is associated in a removable manner with the central supporting axis 13.

In this way, the cogset 2 is associated with the frame T of the bicycle B, while the body 7 carrying the wheel R can be removed, e.g. for the replacement of the wheel itself.

Contrarily to known solutions, therefore, the cogset 2 is not associated with the wheel R but with the frame T, and the wheel R can therefore be removed independently of the cogset 2.

The cogset 2 is provided with a plurality of cogs 4 of different sizes and arranged side by side starting from the smallest-sized cog 4a to the largest-sized cog 4b.

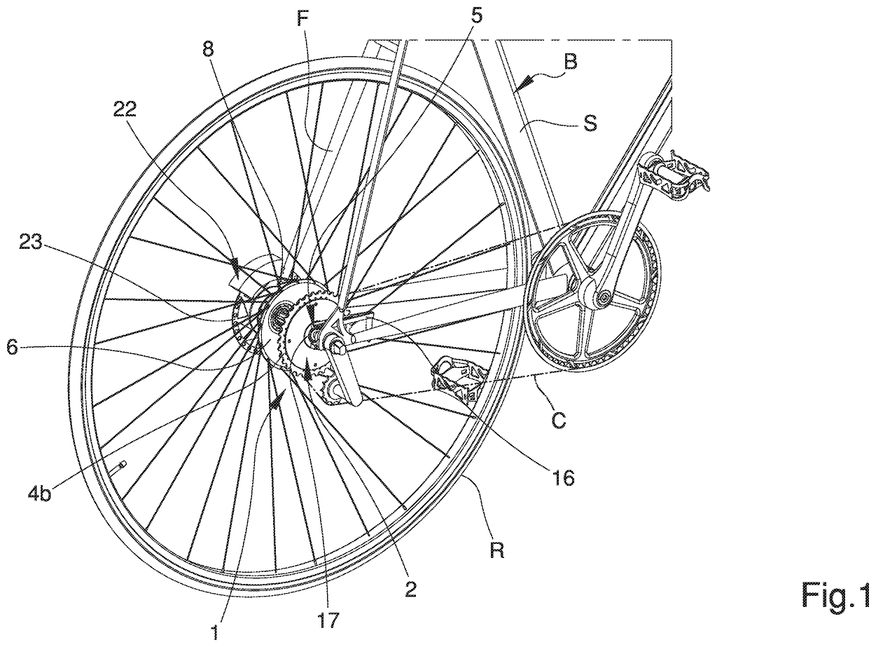

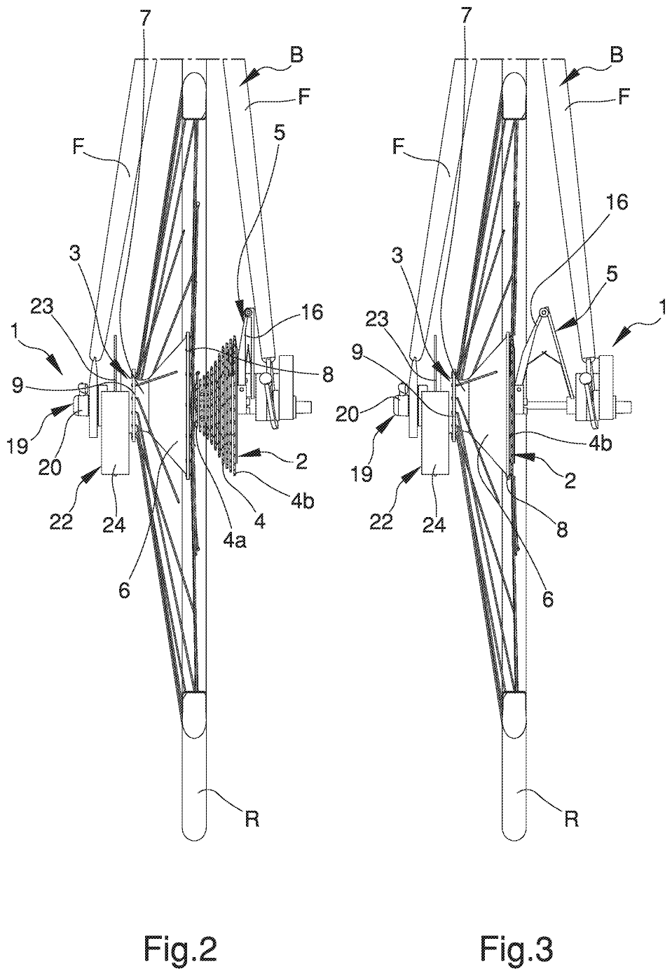

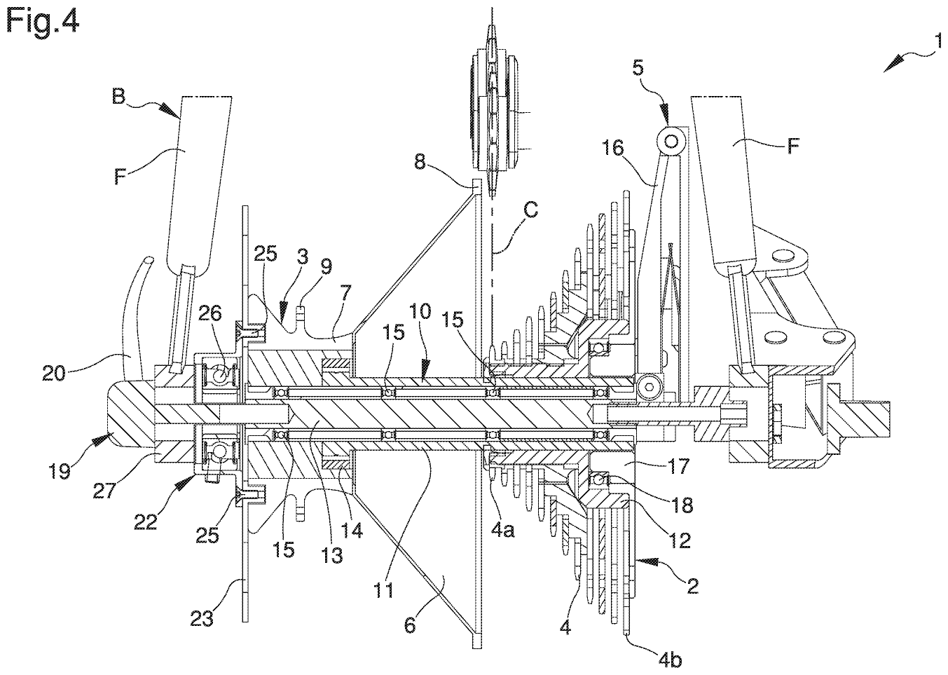

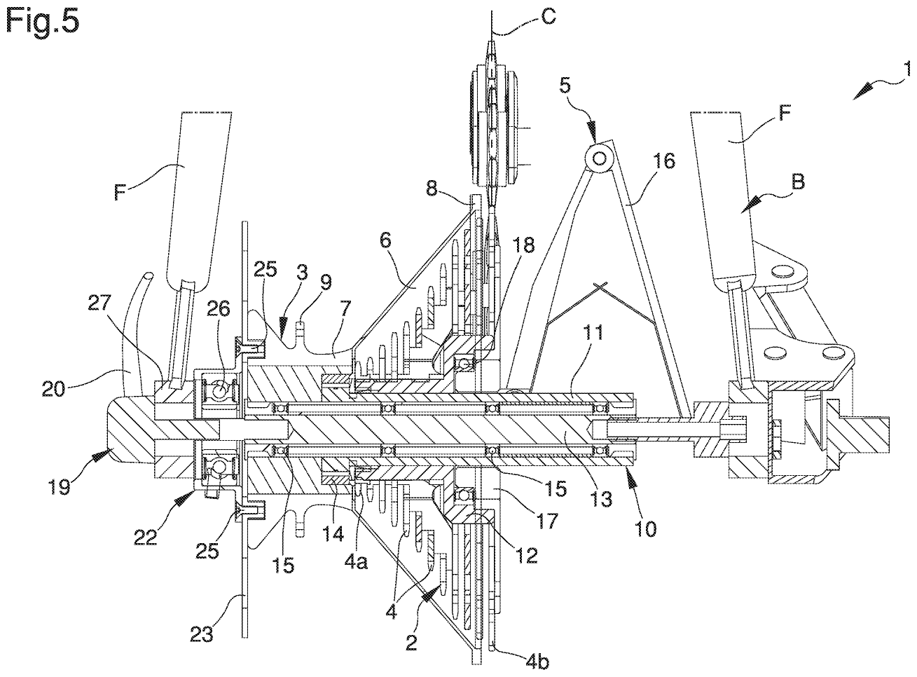

The system 1 also comprises movement means 5 adapted to move the cogset 2 on the hub 3 between a first extreme position, shown in FIGS. 2 and 4, in which the smallest-sized cog 4a is positioned on a transmission chain C of the bicycle B, and a second extreme position, shown in FIGS. 3 and 5, in which the largest-sized cog 4b is positioned on the chain C.

Therefore, by moving the cogset 2 by means of the movement means 5 it is possible to select the desired gear by positioning each of the cogs 4 so as to align them with the chain C. In this way, the aligned cog 4 is therefore engaged by the chain C.

Advantageously, the cogset 2 is associated with the hub 3 with the smallest-sized cog 4a facing the wheel R and with the largest-sized cog 4b facing outwards.

In practice, therefore, the cogset 2 is arranged between the wheel R and one of the forks F of the frame T of the bicycle B with the cogs 4 aligned from the smallest to the largest, where the smallest-sized cog 4a faces the wheel R, while the largest-sized cog 4b faces the fork F.

Advantageously, moreover, the supporting body 7 of the wheel R comprises a housing 6 adapted to house partially and progressively the cogset 2 when it is moved from the first extreme position (FIGS. 2 and 4) towards the second extreme position (FIGS. 3 and 5).

In particular, according to a preferred embodiment of the system 1, when the cogset 2 is in the second extreme position (FIGS. 3 and 5), the housing 6 houses all the cogs 4 of the cogset 2 with the exception of the largest-sized cog 4b. Specifically, in this second extreme position, the largest-sized cog 4b is outside the housing 6 and is engaged by the chain C.

According to a preferred embodiment, shown in the figures, the housing 6 is formed inside at least one portion of the body 7 of the hub 3.

In particular, according to this preferred embodiment, the portion of the body 7 of the hub 3 provided with the housing 6 comprises a first flange 8 for fixing the spokes of the wheel R.

A second flange 9 is formed at a second portion of the body 7 of the hub 3. Advantageously, again according to the preferred embodiment shown in the figures, the housing 6 has a substantially frusto-conical hollow shape with an increasing cross-section from the laying plane of the wheel R towards the outside, i.e. towards the fork F.

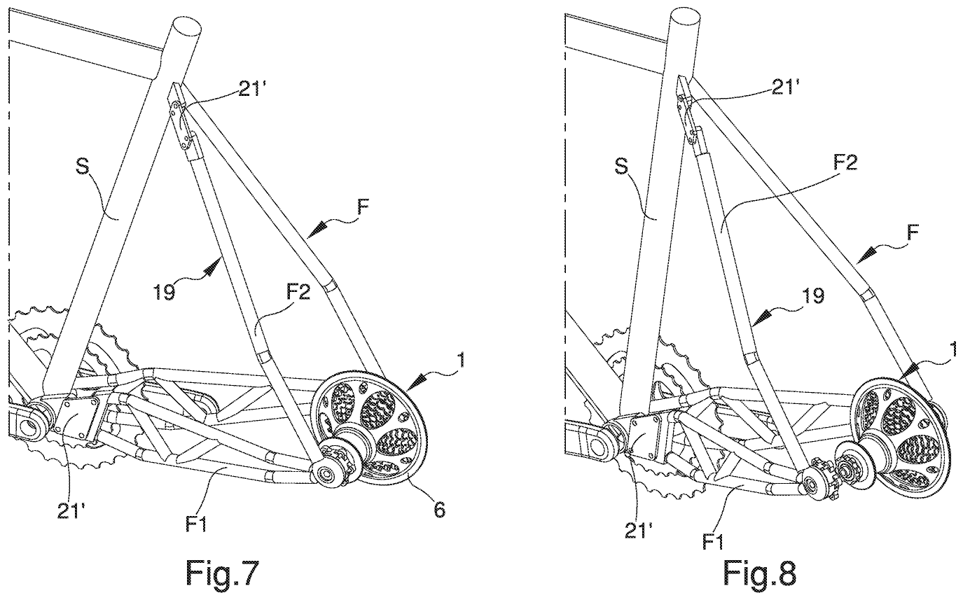

Conveniently, according to a possible variant, shown in FIGS. 7 and 8, the walls of the housing 6 are provided with a plurality of openings which are adapted to reduce the overall weight thereof.

In practice, therefore, when the cogset 2 is in the second extreme position it is housed to size and almost completely inside the housing, with the exception of the largest-sized cog 4b which is external to the housing 6 and is engaged by the chain C.

The system 1 comprises supporting and guiding means 10 of the cogset 2 on the hub 3, which are adapted to support the cogset 2 on the central supporting axis 13 and to guide the sliding of the cogset 2 along the longitudinal axis of the central supporting axis 13.

In particular, the supporting and guiding means 10 comprise a straight guide element 11 associated with the central supporting axis 13 and with the body 7 and a supporting element 12 of the cogset 2 which is associated sliding with the straight guide element 11.

Advantageously, the straight guide element 11 is made up of a first tubular element which is fitted axially revolving on the central supporting axis 13 of the hub 3.

Preferably, the straight guide element 11 is arranged coaxially with respect to the central supporting axis 13 and is provided with sliding coupling means with the supporting element 12.

For example, these sliding coupling means may comprise at least one external longitudinal groove/projection of the straight guide element 11 to which at least one internal longitudinal projection/groove of the supporting element 12 can be coupled in a sliding manner.

Moreover, the supporting element 12 is made up of a second tubular element provided with the cogset 2 and fitted axially sliding on the first tubular element 11.

The second tubular element 12 is provided on the inner surface of said at least one internal longitudinal projection/groove coupled sliding to the external longitudinal groove/projection of the first tubular element 11.

Moreover, the supporting and guiding means 10 comprise at least one free wheel mechanism 14 operatively interposed between the hub 3 and the cogset 2. In particular, the free wheel mechanism 14 is operatively interposed between the straight guide element 11 and the body 7.

Furthermore, the supporting and guiding means 10 comprise a plurality of bearings 15 interposed between the inner surface of the first tubular element 11 and the outer surface of the central supporting axis 13.

The movement means 5 of the system 1 comprise push/pull elastic means 16 of the cogset 2.

With reference to a possible embodiment, illustrated in FIGS. 1 to 6, the elastic means 6 are operatively interposed between the cogset 2 and the fork F of the frame T of the bicycle B.

Moreover, again with reference to this possible embodiment, the movement means 5 comprise a push/pull element 17 of the cogset 2 associated axially sliding with the straight guide element 11, and the elastic means 16 are operatively interposed between the push/pull element 17 and the fork F of the frame T.

In particular, the cogset 2 is locked together with the push/pull element 17 along a sliding direction on the straight guide element 11 and is free to rotate with respect to the push/pull element 17 around this sliding direction.

Preferably, the movement means 5 comprise at least one bearing 18 operatively interposed between the cogset 2 and the push/pull element 17.

In particular, according to a preferred embodiment, shown in the figures, the push/pull element 17 is housed inside the supporting element 12 and the bearing 18 is interposed between the internal surface of the supporting element 12 and the external surface of the push/pull element 17.

According to the possible embodiment shown in FIGS. 1 to 6, the elastic means 16 comprise at least one thrust spring.

Specifically, with reference to a possible embodiment, the elastic means 16 are made up of a pair of thrust springs positioned side by side and interposed between the frame and the push/pull element 15.

According to a further possible embodiment, not shown in the figures, the elastic means 16 operate to bring the cogset 2 from the second extreme position towards the first extreme position. In this way, therefore, the elastic means 16 operate during the shift of the chain C from a larger cog 4 to a smaller cog 4. Conveniently, in this way the elastic means 16 must carry out a minimum push/pull operation.

Furthermore, different positions of the elastic means cannot be ruled out.

Furthermore, different embodiments of the movement means 5 cannot be ruled out in which, for example, the movement is carried out by means of motorized actuators or the like. For example, the movement means could comprise an electronically-controlled internal mechanism, for moving the push/pull element 17.

Conveniently, according to a possible embodiment shown in FIGS. 1 to 6, the gearshift cable (not shown in the figures) is connected to the push/pull element 17 for dragging the cogset 2 towards the first extreme position, counteracting the operation of the elastic means 16.

A different positioning and fixing of the gearshift cable cannot be ruled out. Conveniently, according to a preferred embodiment, the gearshift cable is adapted to pull the cogset 2 between the first extreme position and the second extreme position. This way, therefore, the cable operates in traction during the shift of the chain C from a smaller cog 4 to a larger cog 4. Conveniently, therefore, the required force can be applied manually by the cyclist.

Advantageously, the system 1 comprises quick assembly/removal means for assembling/removing the wheel R onto/from the hub 3, independently of the cogset 2, globally indicated in the figures with reference numeral 19.

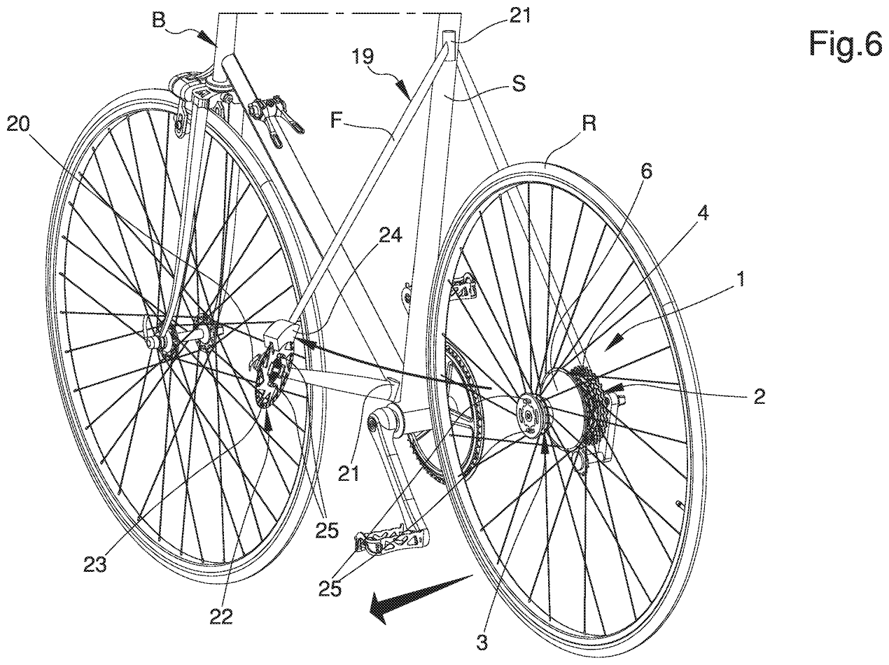

A first possible embodiment of the quick assembly/removal means 19 is shown in FIG. 6.

A second possible embodiment of the quick assembly/removal means is shown in FIGS. 7 and 8.

It is pointed out how the quick assembly/removal means 19 are necessary in order to obtain quick and easy removal and assembly of a wheel R on a bicycle provided with the system 1 according to the invention.

In fact, in a bicycle B provided with the system 1 it would be difficult to remove and replace the wheel using conventional systems.

However, the use of the quick assembly/removal means 19 on bicycles provided with conventional transmission gears, such as e.g. derailleur gears, cannot be ruled out.

In particular, the quick assembly/removal means 19 comprise at least one unlocking/locking element 20 of the supporting body 7 of the wheel R with respect to a fork F of the frame T of the bicycle B.

Furthermore, the quick assembly/removal means 19 comprise rotation means 21 for rotating the fork F with respect to the rest of the frame T between a first locking position, in which one end of the fork F is approached and locked on the axis 13 of the hub 3 by means of the unlocking/locking element 20, and a removal position, in which the end of the fork F is unlocked and rotated with respect to the frame T and moved away from the axis 13 of the hub 3 for the removal of the wheel R.

According to a possible embodiment, schematically shown in FIG. 6, the fork F is hinged to the tubular S of the frame T which carries the saddle.

In particular, in this case the rotation means 21 are preferably composed of one or more hinges arranged between the fork F and the tubular S of the frame T. Advantageously, according to a further embodiment, shown in FIGS. 7 and 8, the rotation means 21 comprise at least one elastically flexible element 21′ made along at least one stretch of one of the forks F.

In particular, with reference to such a solution, the rotation means comprise a first and a second elastically flexible element 21′ made along the respective stretches of the low lining F1 and of the high lining F2 of one of the rear forks F of the bicycle B, respectively.

Preferably, the first and second elastically flexible elements 21′ connect the low lining F1 and the high lining F2 to the tubular S of the frame T.

Advantageously, the elastically flexible elements 21′ are made of respective plates of elastically flexible metal, preferably titanium.

Usefully, each metal plate 21′ is preformed to keep the fork F in the removal position. This way, when the unlocking/locking element 20 is removed, the fork F, and therefore the low lining F1 and the high lining F2, is automatically brought to the removal position. Once the wheel R has been replaced, the fork F can be returned to the locking position by applying a push. This makes it possible to further speed up and simplify the removal and assembly of a wheel. Rotation means of a different type cannot however be ruled out.

For example, the rotation means can provide for the use of a rotatable element axially housed inside the tubular S of the bicycle B, connected to one of the rear forks F through suitable openings made on the tubular S itself.

Advantageously, according to one possible embodiment, the system 1 comprises at least one disc brake system 22, as shown in the figures from 1 to 6. In particular, the disc brake system 22 comprises a disc 23 which is associated in a removable manner with the hub 3 and a clamp 24 adapted to be closed on the disc 23 during braking.

Advantageously, the quick assembly/removal means 19 comprise coupling/release means 25 of the disc 23 to/from the hub 3.

Preferably, the coupling/release means are made up of mechanical coupling means.

In particular, with reference to the preferred embodiment shown in the figures, the coupling/release means 25 comprise a plurality of pins formed on the internal surface of the disc 23, which are adapted to be fitted by interlocking into respective seats formed on the hub 3.

This way, once coupled, the disc 23 and the hub 3 are locked together in rotation.

In order to allow the rotation of the disc with respect to the end of the fork F, the system 1 comprises at least one bearing 26 fitted between a backing 27 at the end of the fork F and the disc 23.

Therefore, when the fork F is in the removal position, with the end of the fork F unlocked and rotated with respect to the frame T and moved away from the axis 13 of the hub 3 for the removal of the wheel R, the disc 23 is uncoupled and moved away from the hub 3, by simplifying and speeding up considerably the disassembly and replacement operations of the wheel R.

Advantageously, the system 1 can comprise quick assembly/removal means similar to those described above and installed at the front forks of the bicycle B.

Advantageously, moreover, the system 1 can comprise a chain tensioner suitably associated with the fork F and adapted to maintain the correct tension of the chain for each of the selected transmission gears.

It has in practice been found that the described invention achieves the intended objects.

In particular, the fact is underlined that the system according to the invention allows keeping the chain stationary and in line during use, while at the same time allowing the use of a large number of cogs.

Advantageously, the particular arrangement of the cogs, with the smallest-sized cog arranged in the proximity of the wheel and the largest-sized cog arranged towards the fork, together with the presence of the particular housing for the cogset made on the wheel hub, allow the use and movement of a large number of cogs, while at the same time ensuring simple, fast and effective transmission gear selection and a pleasant aesthetic impact.

Moreover, the quick assembly/removal means of the system according to the invention make it possible to considerably simplify and speed up wheel removal and replacement operations.

1. Selection system of the transmission gears in bicycles or the like, comprising a cogset associated axially sliding with a hub of a wheel of a bicycle and provided with a plurality of cogs of different sizes and arranged alongside one another, starting from the smallest-sized cog to the largest-sized cog, and movement means of said cogset on said hub between a first extreme position, in which said smallest-sized cog is positioned on a transmission chain of said bicycle, and a second extreme position, in which said largest-sized cog is positioned on said chain, said cogset being associated with said hub with said smallest-sized cog facing said wheel and with said largest-sized cog facing outwards, wherein said selection system comprises quick assembly/removal means of said wheel independently of said cogset.

2. System according to claim 1, wherein said hub comprises a central supporting axis locked together with the forks of the bicycle, by the fact that said cogset is associated revolving and axially sliding with said central supporting axis, and by the fact that said hub comprises a supporting body for said wheel which is associated revolving and in a removable manner with said central supporting axis.

3. System according to claim 2, wherein said quick assembly/removal means comprise at least one unlocking/locking element of said supporting body of the wheel on said central supporting axis and with respect to a fork of said bicycle.

4. System according to claim 3, wherein said quick assembly/removal means comprise rotation means for rotating said fork between a first locking position, in which one end of said fork is approached and locked on said central supporting axis by means of said unlocking/locking element, and a removal position, in which said end of the fork is rotated and spaced away from said central supporting axis for the removal of said wheel.

5. System according to claim 1, comprising at least a disc brake system provided with a disc which is associated in a removable manner with said hub and with a clamp adapted to be closed on said disc during braking, and wherein said quick assembly/removal means comprise coupling/release means of said disc to/from said hub.

6. System according to claim 1, comprising at least a housing locked together with said wheel and adapted to house partially said cogset when said cogset is moved from said first extreme position towards said second extreme position.

7. System according to claim 6, wherein said housing is formed inside at least one portion of said body of said hub.

8. System according to claim 1, comprising supporting and guiding means of said cogset on said central supporting axis, adapted to support said cogset on said central supporting axis and to guide the sliding of said cogset with respect to said central supporting axis.

9. System according to claim 8, wherein said supporting and guiding means comprise at least a straight guide element associated with said central supporting axis and with said body and at least a supporting element of said cogset associated sliding with said straight guide element.

10. System according to claim 9, wherein said straight guide element comprises a first tubular element which is fitted revolving around said central supporting axis, and wherein said supporting element comprises at least a second tubular element provided with said cogset and fitted sliding on said first tubular element.

11. System according to claim 1, wherein said supporting and guiding means comprise at least one free wheel mechanism operatively interposed between said hub and said cogset.

12. System according to claim 1, wherein said movement means comprise push/pull elastic means of said cogset.

13. System according to claim 12, wherein said movement means comprise at least a push/pull element of said cogset associated axially sliding with said hub, said elastic means being operatively interposed between said push/pull element and said frame.

14. System according to claim 13, wherein said cogset is locked together with said push/pull element along a sliding direction on said hub and is free to rotate with respect to said push/pull element around said sliding direction.

15. Quick assembly/removal means of a wheel in bicycles, comprising rotation means for rotating at least one fork of a bicycle between a first locking position, in which one end of said fork is approached and locked on a hub of a wheel of said bicycle by means of an unlocking/locking element, and a removal position, in which said end of the fork is rotated and spaced away from said hub for the removal of said wheel.
